(19) United States
(12) Patent Application Publication
(10) Pub. No.: US 2023/0178785 A1
(43) Pub. Date: Jun. 8, 2023

(54) ELECTROCHEMICAL STACK ASSEMBLY

(71) Applicants: HYUNDAI MOTOR COMPANY, Seoul (KR); Kia Corporation, Seoul (KR)

(72) Inventors: Kwi Seong JEONG, Yongin-si (KR); Ji Soo KIM, Seongnam-si (KR)

(73) Assignees: HYUNDAI MOTOR COMPANY, Seoul (KR); Kia Corporation, Seoul (KR)

(21) Appl. No.: 17/837,777

(22) Filed: Jun. 10, 2022

(30) Foreign Application Priority Data
Dec. 2, 2021 (KR) 10-2021-0171242

(51) Int. Cl. H01M 8/2475; H01M 50/505; H01M 50/543

(52) U.S. Cl. CPC H01M 8/2475; H01M 50/505; H01M 50/543

(57) ABSTRACT

The present disclosure relates to an electrochemical stack assembly including an enclosure in which a plurality of cells arranged in a reference direction are disposed, the enclosure including an opening, an enclosure cover seated on the enclosure to cover the opening and a fastening member passing through a first hole of the enclosure and a second hole of the enclosure cover to fasten the enclosure and the enclosure cover to each other, wherein a size of the second hole is different from a size of the first hole.

### CROSS-REFERENCE TO RELATED APPLICATION

This application claims the benefit of priority to Korean Patent Application No. 10-2021-0171242, filed in the

Korean Intellectual Property Office on Dec. 2, 2021, the entire contents of which are incorporated herein by reference.

### TECHNICAL FIELD

The present disclosure relates to an electrochemical stack assembly.

### BACKGROUND

Electrochemical stacks are configured by stacking a plurality of cells, then coupling end plates for supporting the cells to outermost sides, and arranging and fastening the cells between the end plates.

The electrochemical stack as configured above is coupled to a terminal block through a bus bar and is connected to an external electric supply device.

Meanwhile, the number of cells stacked on the electrochemical stack may be variously changed as needed. However, in the related art, there is inconvenience in that, whenever the number of cells stacked on the electrochemical stack is changed, specifications of the bus bar or the terminal block should be changed.

### SUMMARY

The present disclosure has been made to solve the above-mentioned problems occurring in the prior art while advantages achieved by the prior art are maintained intact.

An aspect of the present disclosure provides an electrochemical stack assembly to which a bus bar and a terminal block having a single specification may be applied regardless of the number of stacked cells.

According to an aspect of the present disclosure, an electrochemical stack assembly may include an enclosure in which a plurality of cells arranged in a reference direction are arranged and which includes an opening, an enclosure cover seated on the enclosure to cover the opening, and a fastening member passing through a first hole of the enclosure and a second hole of the enclosure cover to fasten the enclosure and the enclosure cover to each other, wherein a size of the second hole is different from a size of the first hole.

In another example, an area of the enclosure cover may be greater than a size of an area occupied by the opening.

In still another example, the second hole may be located in an outer region that is a region of the enclosure cover not overlapping the opening.

In yet another example, the second hole may have a slot shape extending in the reference direction.

In yet another example, the enclosure cover may be disposed to cover an entire area of the opening when a first end of the second hole in the reference direction overlaps the first hole.

In yet another example, the enclosure cover may be disposed to cover an entire area of the opening while being transited from to a state in which the first end of the second hole in the reference direction and the first hole overlap each other to a state in which a second end of the second hole in a direction opposite to the reference direction and the first hole overlap each other.

In yet another example, the electrochemical stack assembly may further include a terminal block coupled to the enclosure cover, wherein the enclosure cover may include a cover body and an insertion hole communicating with the opening, and the terminal block may be inserted into the insertion hole.

In yet another example, the electrochemical stack assembly may further include a current collection plate including a current collection terminal electrically connected to the plurality of cells to transmit power of the plurality of cells to a contact target, and a bus bar electrically connecting the terminal block and the current collection terminal to each other and disposed inside the enclosure.

In yet another example, the electrochemical stack assembly may further include a pair of end plates connected to the current collection plate and arranged between the plurality of cells, wherein the current collection terminal may include a positive terminal disposed in any one of the pair of end plates, and a negative terminal disposed in a remaining one of the pair of end plates, and the bus bar may include a first bus bar connected to the positive terminal, and a second bus bar connected to the negative terminal.

In yet another example, the terminal block may include a first terminal block connected to the first bus bar and a second terminal block connected to the second bus bar, the enclosure cover may include a first enclosure cover coupled to the first terminal block and a second enclosure cover coupled to the second terminal block, and the opening may include a first opening covered by the first enclosure cover and a second opening covered by the second enclosure cover.

In yet another example, the second opening may be spaced apart from the first opening in the reference direction.

In yet another example, the fastening member may include a first fastening member that passes through a (1-1)^{th} hole of the enclosure and a (2-1)^{th} hole of the first enclosure cover to fasten the enclosure and the first enclosure cover to each other, the (2-1)^{th} hole may include a portion overlapping the (1-1)^{th} hole and is larger than the (1-1)^{th} hole, and the (1-1)^{th} hole may overlap an end of the (2-1)^{th} hole in a direction opposite to the reference direction when the first enclosure cover and the second enclosure cover are closest to each other in the reference direction.

In yet another example, the terminal block may include a terminal opening opens upward, and the bus bar may include an exposure part exposed to an outside of the electrochemical stack assembly through the terminal opening.

In yet another example, the exposure part may include a region protruding outward from the terminal block.

In yet another example, the opening may be opens upward, and the enclosure cover may be seated on an upper surface of the enclosure.

In yet another example, a size of the second hole may be greater than a size of the first hole.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating an electrochemical stack assembly according to an exemplary embodiment of the present disclosure;

FIG. 2 is a concept view illustrating a cell;

FIG. 3 is a view illustrating an upper surface of an enclosure of the electrochemical stack assembly according to an exemplary embodiment of the present disclosure;

FIG. 4 is a view illustrating a state before an enclosure cover is seated on the enclosure;

FIG. 5 is a view illustrating an upper surface of the enclosure cover of the electrochemical stack assembly according to an exemplary embodiment of the present disclosure;

FIGS. 6 and 7 are views illustrating the enclosure cover, a terminal block, and a bus bar of the electrochemical stack assembly according to an exemplary embodiment of the present disclosure;

FIG. 8 is a view illustrating first and second enclosure covers, first and second terminal blocks, and first and second bus bars;

FIG. 9 is a view illustrating the first and second terminal blocks and the first and second bus bars arranged in an opening;

FIGS. 10 and 11 are views illustrating a state in which the first and second enclosure covers are maximally spaced apart from each other; and

FIGS. 12 and 13 are views illustrating a state in which the first and second enclosure covers are closest to each other.

### DETAILED DESCRIPTION

Hereinafter, some embodiments of the present disclosure will be described in detail with reference to the exemplary drawings. When components in the drawings are designated by reference numerals, the same components have the same reference numerals as far as possible even though the components are illustrated in different drawings. Further, in description of the embodiments of the present disclosure, when it is determined that a detailed description of a related well-known configuration or function disturbs understanding of the embodiments of the present disclosure, the detailed description will be omitted.

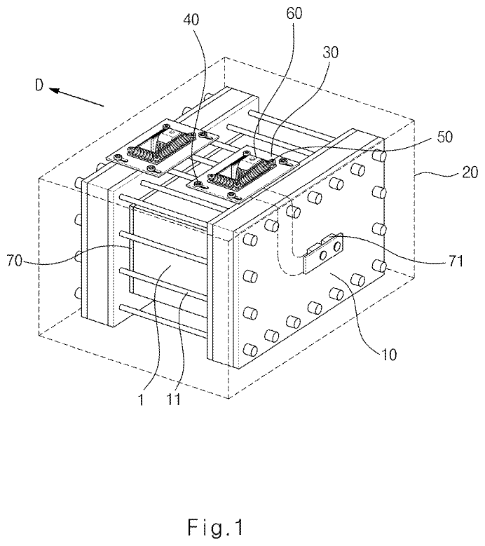

FIG. 1 is a view illustrating an electrochemical stack assembly according to an embodiment of the present disclosure. As illustrated in FIG. 1, an electrochemical stack assembly according to the embodiment of the present disclosure may include an end plate 10, an enclosure 20, an enclosure cover 30, and a fastening member 40.

As an example, the end plate 10 may be provided as a pair of end plates 10. A plurality of cells 1 arranged in a reference direction D may be arranged between the pair of end plates 10. However, the present disclosure is not limited thereto. Further, other types of electrochemical stack assemblies in which one end plate may be present and one surface of the enclosure, which will be described below, may serve as the other one end plate may be possible. The end plate 10 may serve to support and fix the plurality of cells 1.

The end plate 10 may be connected to a current collection plate 70. The current collection plate 70 may include a current collection terminal 71. The current collection terminal 71 may be a terminal that is electrically connected to the plurality of cells to transmit power of the plurality of cells to a contact target.

The pair of end plates 10 may be connected to each other through a plurality of fastening members 11. The plurality of fastening members 11 may extend in the reference direction D and may be disposed outside the plurality of cells 1. A separation distance between the pair of end plates 10 may be adjusted by adjusting the degree of tightening the fastening member 11 according to the number of cells.

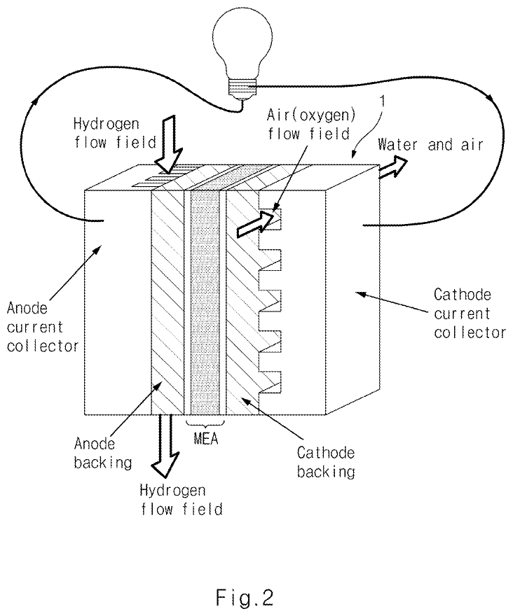

However, the pair of end plates 10 are not necessarily connected to each other in this manner, and the fastening member 11 may fasten the plurality of cells 1 in various forms such as a bar form, a belt form, and a rigid rope form. FIG. 2 is a concept view illustrating a cell. As illustrated in FIG. 2, the cell 1 may include a membrane-electrode assembly (MEA). The MEA may include a solid polymer electrolyte membrane that may move hydrogen ions, and a cathode and an anode that are electrode layers coated with a catalyst so that hydrogen and oxygen may react and are formed at both surface of the solid polymer electrolyte membrane.

Further, a gas diffusion layer (GDL) may be stacked on an outer part of the MEA, that is, an outer part in which the cathode and the anode are located, and a bipolar plate having a flow field through which a reaction gas is supplied and cooling water passes may be located outside the GDL.

Further, a gasket for sealing a fluid may be stacked between the bipolar plates. The gasket may be provided in a state of being integrally injected with the MEA or the bipolar plate or being molded as a separate solid gasket.

The end plate 10 may be disposed inside the enclosure 20. As an example, the enclosure 20 may correspond to a hexahedron, and the end plate 10 may be disposed in an inner space of the enclosure 20. However, the present disclosure is not limited thereto. Further, the one surface and the other surface of the enclosure may be replaced with the pair of end plates or the one surface of the enclosure may also be replaced with the one end plate.

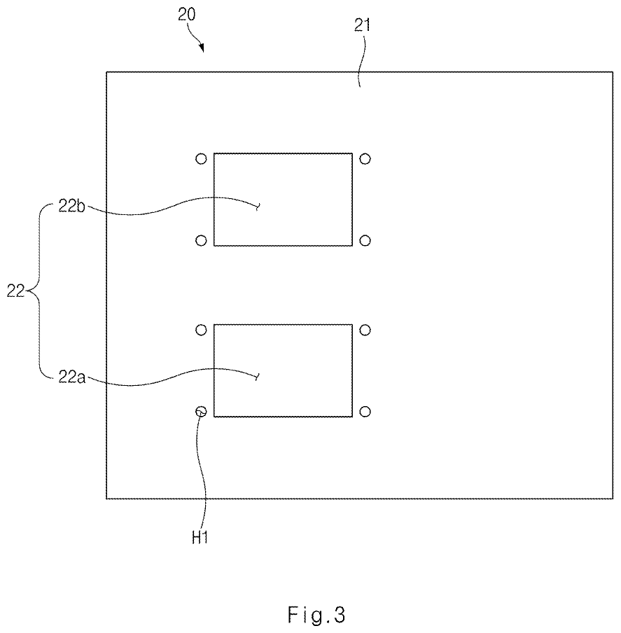

FIG. 3 is a view illustrating an upper surface of an enclosure of the electrochemical stack assembly according to an exemplary embodiment of the present disclosure. The enclosure 20 may include an opening 22 opens upward. The opening 22 may be formed in an upper surface 21 of the enclosure 20.

However, a location of the opening 22 is an example, and the opening 22 may be formed in a side surface of the enclosure 20. Hereinafter, a case in which the opening 22 is formed in the upper surface 21 of the enclosure 20 and is open s upward will be described in detail.

A first hole H1 may be formed in the enclosure 20. The fastening member 40, which will be described below, may be fastened to the first hole H1. The first hole H1 may have a diameter corresponding to the diameter of the fastening member 40. This means that, when the fastening member 40 is fastened to the first hole H1, a location of the fastening member 40 is fixed.

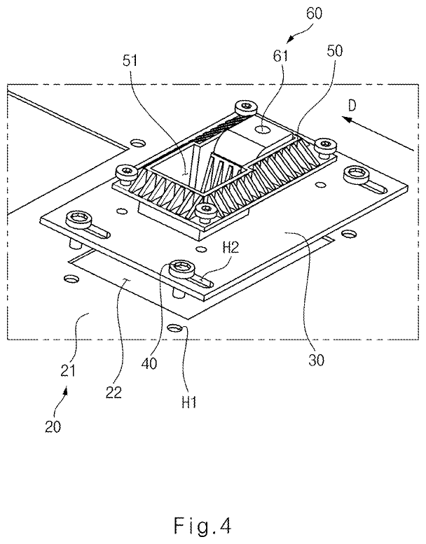

The enclosure cover 30 may be seated on the upper surface 21 of the enclosure 20 to cover the opening 22. FIG. 4 is a view illustrating a state before an enclosure cover is seated on the enclosure.

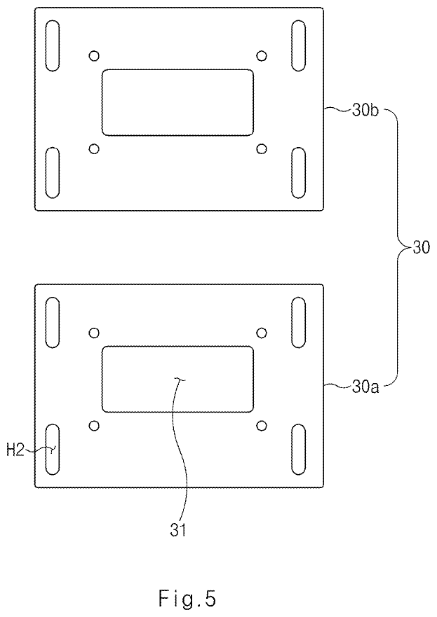

FIG. 5 is a view illustrating an upper surface of the enclosure cover of the electrochemical stack assembly according to an exemplary embodiment of the present disclosure. As illustrated in FIG. 5, a second hole H2 may be formed in the enclosure cover 30. In a state in which the enclosure 20 and the enclosure cover 30 are coupled, the second hole H2 may include a portion overlapping the first hole H1 when viewed from the top.

The size of the second hole H2 may be different from the size of the first hole H1. As an example, as illustrated in FIG. 3, the size of the second hole H2 may be greater than the size of the first hole H1. However, this is merely an example, and the size of the second hole H2 may be smaller than the size of the first hole H1. Hereinafter, a case in which the size of the second hole H2 is greater than the size of the first hole H1 will be described.

The fastening member 40 may pass through the first hole H1 and the second hole H2 to fasten the enclosure 20 and the enclosure cover 30 to each other. In this case, the fastening may be achieved by fastening the enclosure 20 and the enclosure cover 30 by pressing an upper surface of the enclosure cover 30 by a lower surface of the fastening member 40 downward. As an example, the fastening member 40 may be a bolt.

Meanwhile, the size of the second hole H2 is greater than the size of the first hole H1, and the location of the fastening member 40 fastened through the first hole H1 is fixed. When the fastening member 40 is loosely fastened, the enclosure cover 30 may move relative to the enclosure 20 within a range of the size of the second hole H2. This means that, as the number of cells increases or decreases, when a location of the enclosure cover 30 needs to be adjusted, the fastening member 40 is loosely fastened, and thus the enclosure cover 30 may move relative to the enclosure 20.

Thus, according to the present disclosure, since the location of the enclosure cover 30 may be adjusted, a terminal block 50 and a bus bar 60, which will be described below, may be applied as a single specification, and thus working efficiency can be increased, and a production cost can be reduced.

When viewed from the top, the enclosure cover 30 may be formed to have an area that is larger than the size of an area occupied by the opening 22. In this case, the second hole H2 may be formed in an outer region that is a region of the enclosure cover 30 not overlapping the opening 22 when viewed from the top.

Meanwhile, the second hole H2 may have a slot shape extending in the reference direction D. When the fastening member 40 is loosely fastened, the enclosure cover 30 may be guided by the second hole H2 to move in the reference direction D or a direction opposite thereto. This means that the location of the enclosure cover 30 may be adjusted. Meanwhile, the width of the first hole H1 and the width of the second hole H2 may correspond to each other in a vertical direction and a direction perpendicular to the reference direction D. Thus, in a state in which the fastening member 40 is coupled, the enclosure cover 30 may move only in the reference direction D and the direction opposite thereto, and the movement of the enclosure cover 30 in the direction perpendicular to the reference direction D may be restricted.

Meanwhile, the enclosure cover 30 may be disposed to cover the entire opening 22 when an end of the second hole H2 in the reference direction D and the first hole H1 overlap each other. Further, likewise, the enclosure cover 30 may be disposed to cover the entire opening 22 when an end of the second hole H2 in the direction opposite to the reference direction D and the first hole H1 overlap each other. That is, when the enclosure cover 30 is fastened to the enclosure 20 by the fastening member 40, the enclosure cover 30 may always cover the opening 22. This means that the enclosure cover 30 may always cover the opening 22 in a range in which the second hole H2 and the first hole H1 overlap each other.

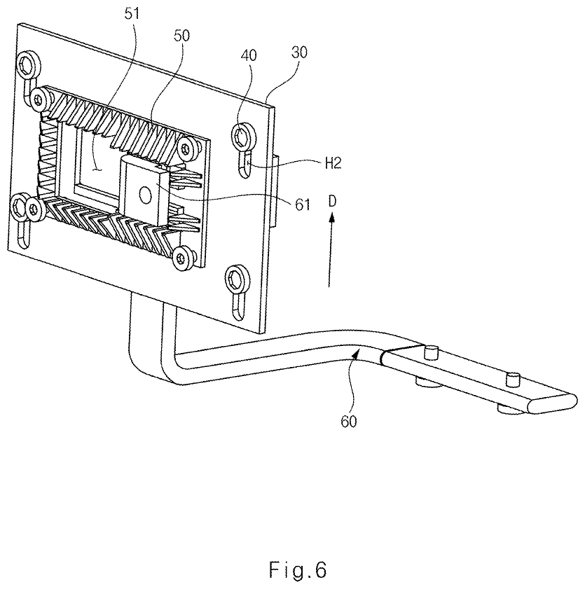

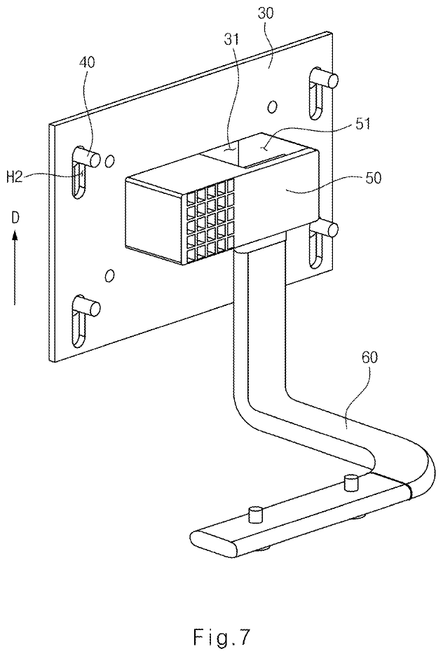

The electrochemical stack assembly according to an exemplary embodiment of the present disclosure may further include the terminal block 50. FIGS. 6 and 7 are views illustrating the enclosure cover, a terminal block, and a bus bar of the electrochemical stack assembly according to an exemplary embodiment of the present disclosure.

The terminal block 50 may be disposed on the upper surface of the enclosure cover 30. The terminal block 50 may be configured to connect the bus bar 60, which will be described below, to an external electric supply device.

The enclosure cover 30 may include a cover body 32 and an insertion hole 31. The insertion hole 31 may be open upward to communicate with the opening 22. The terminal block 50 may be inserted into the insertion hole 31.

The electrochemical stack assembly according to an exemplary embodiment of the present disclosure may further include the bus bar 60. The bus bar 60 may electrically connect the terminal block 50 and the current collection terminal 71 to each other and may be disposed inside the enclosure 20.

The terminal block 50 may include a terminal opening 51 opens upward. As illustrated in FIG. 6, the bus bar 60 may have an exposure part 61 exposed to the outside through the terminal opening 51. The exposure part 61 may include a region protruding upward from an upper surface of the terminal block 50.

The exposure part 61 may be connected to an external connector that is located outside and for electrical connection. As an example, the external connector may be a fuel cell direct current (DC)-DC converter (FDC), but the present disclosure is not limited thereto.

The opening 22 may be formed as a pair of openings 22. As an example, the opening 22 may include a first opening 22a and a second opening 22b. The second opening 22b may be spaced apart from the first opening 22a in the reference direction D. As the opening 22 is formed as a pair, other components may also be provided as a pair.

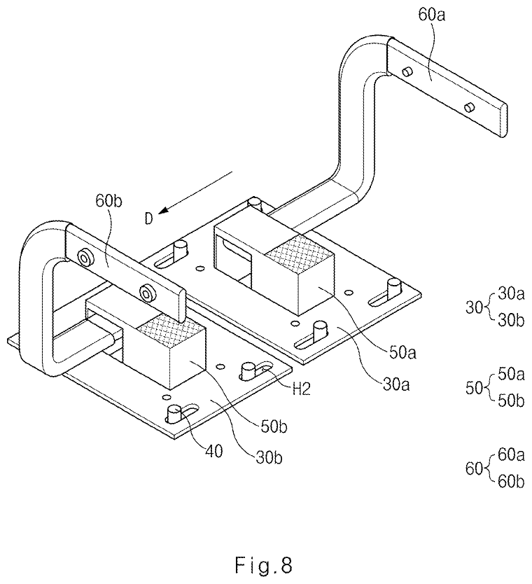

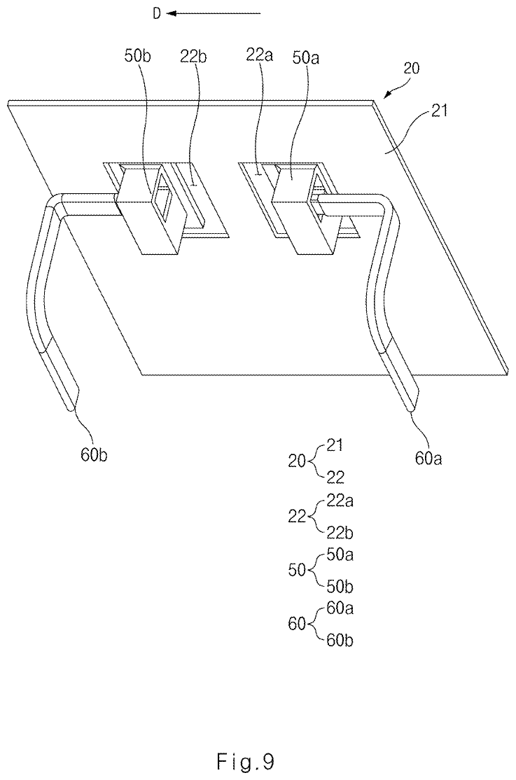

FIG. 8 is a view illustrating first and second enclosure covers, first and second terminal blocks, and first and second bus bars. FIG. 9 is a view illustrating first and second terminal blocks and first and second bus bars arranged in the first and second openings.

Hereinafter, components provided as a pair will be described in detail. The components provided as a pair may include all of characteristics of the components described above.

The current collection terminal 71 may include a positive terminal and a negative terminal. The positive terminal may be formed in any one of the pair of end plates 10. The negative terminal may be formed in the other one of the pair of end plates 10.

The bus bar 60 may include a first bus bar 60a and a second bus bar 60b. The first bus bar 60a may be connected to the positive terminal. The second bus bar 60b may be connected to the negative terminal. The first bus bar 60a and the second bus bar 60b may have the same shape or shapes corresponding to each other.

The terminal block 50 may include a first terminal block 50a and a second terminal block 50b. The first terminal block 50a may be connected to the first bus bar 60a. The second terminal block 50b may be connected to the second bus bar 60b.

The enclosure cover 30 may include a first enclosure cover 30a and a second enclosure cover 30b. The first enclosure cover 30a may be disposed on an upper surface of the first terminal block 50a. The first enclosure cover 30a may cover the first opening 22a. The second enclosure cover 30b may be disposed on an upper surface of the second terminal block 50b. The second enclosure cover 30b may cover the second opening 22b.

According to the present disclosure, even when the number of cells 1 is changed, the enclosure cover 30 may be moved to move the bus bar 60 and the terminal block 50 with no need to newly provide the bus bar 60 and the terminal block 50.

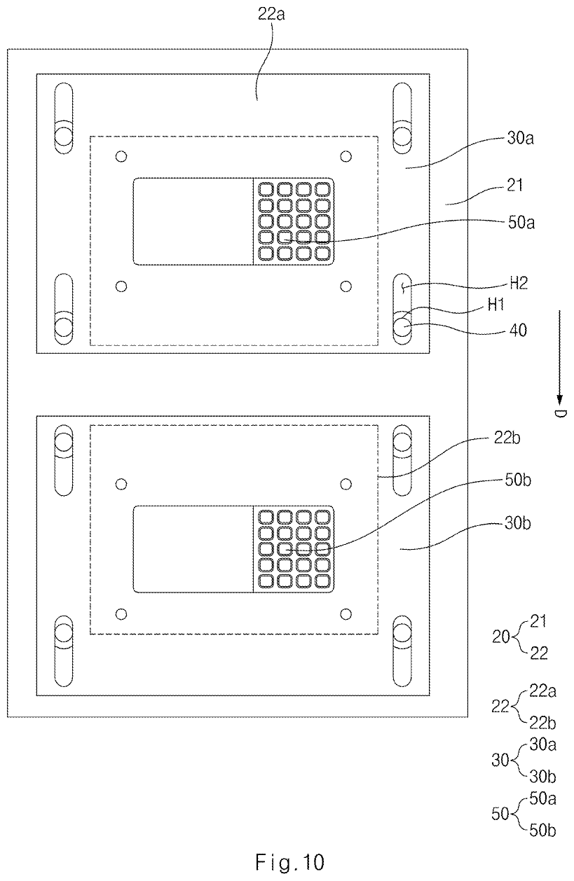

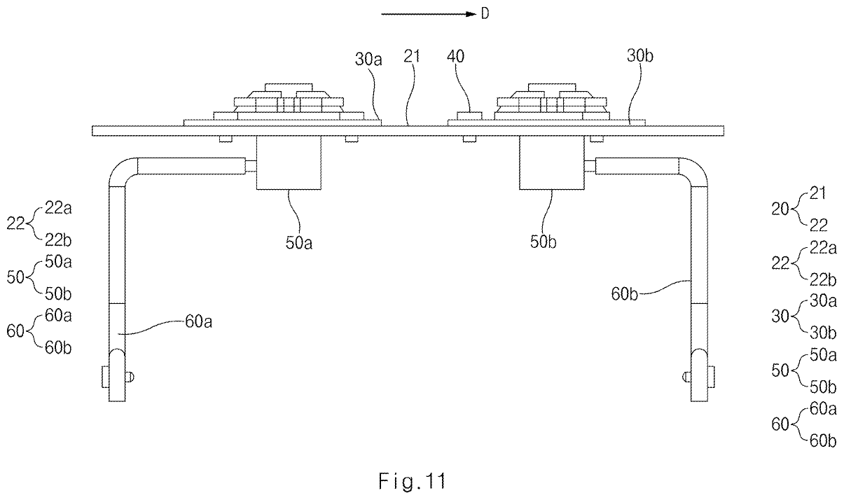

FIGS. 10 and 11 are views illustrating a state in which the first and second enclosure covers are maximally spaced apart from each other. The state of FIGS. 10 and 11 may illustrate locations of respective components when the number of cells is maximum. For reference, FIG. 10 illustrates a state when viewed from the lower side. Further, FIG. 11 illustrates a state when viewed from the rear side.

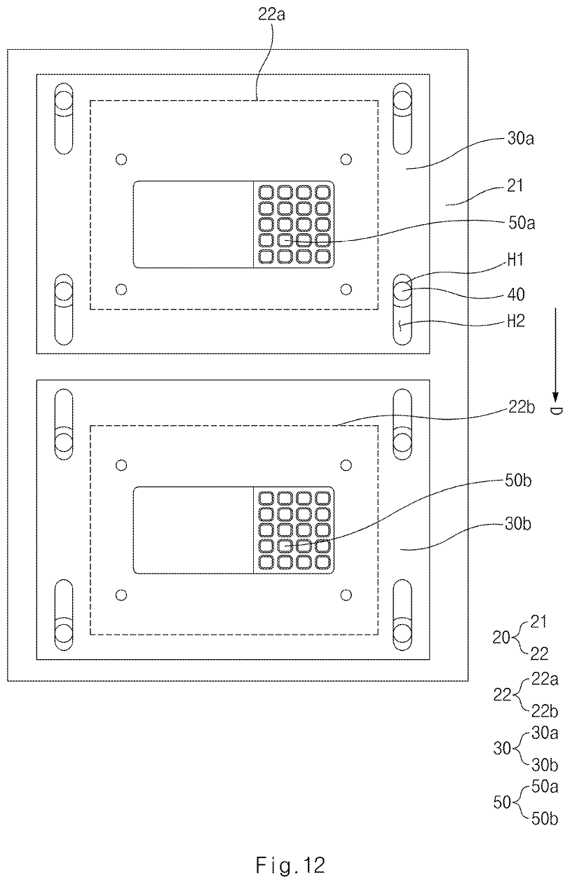

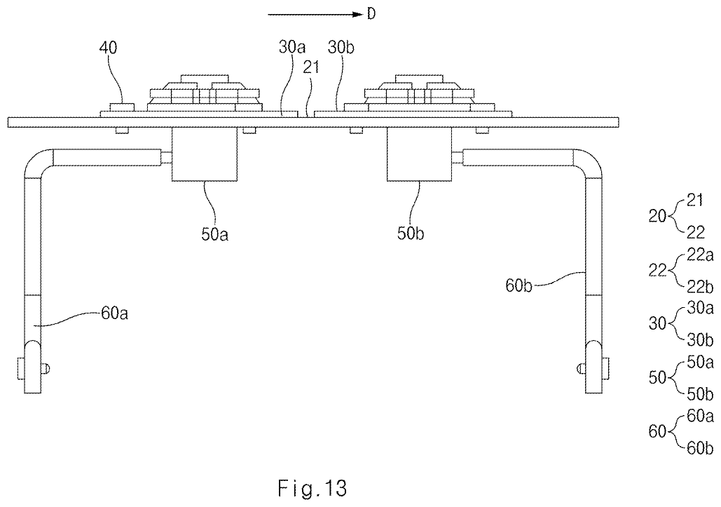

FIGS. 12 and 13 are views illustrating a state in which the first and second enclosure covers are closest to each other. The state of FIGS. 12 and 13 may illustrate locations of respective components when the number of cells is minimum. For reference, FIG. 12 illustrates a state when viewed from the lower side. Further, FIG. 13 illustrates a state when viewed from the rear side.

When a user wants to change the state of FIGS. 10 and 11 to the state of FIGS. 12 and 13, the fastening member 40 may be loosely unfastened, the first enclosure cover 30a and the second enclosure cover 30b move in directions closer to each other, and then the fastening member 40 may be fastened again. This case may be when the number of cells 1 is minimum. This case may mean when a distance between the end plates 10 is minimum.

In contrast, when the user wants to change the state of

FIGS. 12 and 13 to the state of FIGS. 10 an 11, the fastening member 40 may be loosely unfastened, the first enclosure cover 30a and the second enclosure cover 30b move in directions away from each other, and then the fastening member 40 may be fastened again. This case may be when the number of cells 1 is maximum. This case may mean when the distance between the end plates 10 is maximum.

The fastening member 40 may include a first fastening member 41 and a second fastening member 42. The first fastening member 41 may be a member passing through a (1-1)^{th} hole H1a of the enclosure 20 and a (2-1)^{th} hole H2a of the first enclosure cover 30a. The second fastening member 42 may be a member passing through a (1-2)^{th} hole H1b of the enclosure 20 and a (2-2)^{th} hole H2b of the second enclosure cover 30b.

The first hole H1 may include the (1-1)^{th} hole H1a and the (1-2)^{th} hole H1b, and the second hole H2 may include the (2-1)^{th} hole H2a and the (2-2)^{th} hole H2b.

As illustrated in FIG. 10, when the distance between the end plates 10 is maximum, an end of the (2-1)^{th} hole H2a in the reference direction D and the (1-1)^{th} hole H1a may overlap each other. Further, an end of the (2-2)^{th} hole H2b in the direction opposite to the reference direction D and the (1-2)^{th} hole H1b may overlap each other.

As illustrated in FIG. 12, when the distance between the end plates 10 is minimum, an end of the (2-1)^{th} hole H2a in the direction opposite to the reference direction D and the (1-1)^{th} hole H1a may overlap each other. Further, an end of the (2-2)^{th} hole H2b in the reference direction D and the (1-2)^{th} hole H1b may overlap each other.

According to the present disclosure, since a location of an enclosure cover to which a terminal block is coupled may be adjusted, a bus bar and a terminal block having a single specification may be applied, and thus work efficiency can be increased, and production cost can be reduced.

The above description is merely illustrative of the technical spirit of the present disclosure, and those skilled in the art to which the present disclosure belongs may make various modifications and changes without departing from the essential features of the present disclosure. Thus, the embodiments disclosed in the present disclosure are not intended to limit the technology spirit of the present disclosure, but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

What is claimed is:

1. An electrochemical stack assembly comprising:
an enclosure in which a plurality of cells arranged in a reference direction are disposed, the enclosure including an opening;
an enclosure cover seated on the enclosure to cover the opening; and
a fastening member passing through a first hole of the enclosure and a second hole of the enclosure cover to fasten the enclosure and the enclosure cover to each other,
wherein a size of the second hole is different from a size of the first hole.

2. The electrochemical stack assembly of claim 1, wherein an area of the enclosure cover is greater than a size of an area occupied by the opening.

3. The electrochemical stack assembly of claim 2, wherein the second hole is located in an outer region of the enclosure cover not overlapping the opening.

4. The electrochemical stack assembly of claim 2, wherein the second hole has a slot shape extending in the reference direction.

5. The electrochemical stack assembly of claim 3, wherein the enclosure cover is disposed to cover an entire area of the opening when a first end of the second hole in the reference direction overlaps the first hole.

6. The electrochemical stack assembly of claim 5, wherein the enclosure cover is disposed to cover an entire area of the opening while being transited from a state in which the first end of the second hole in the reference direction and the first hole overlap each other to a state in which a second end of the second hole in a direction opposite to the reference direction and the first hole overlap each other.

7. The electrochemical stack assembly of claim 1, further comprising:
a terminal block coupled to the enclosure cover,
wherein the enclosure cover includes:
a cover body; and
an insertion hole communicating with the opening, and
wherein the terminal block is inserted into the insertion hole.

8. The electrochemical stack assembly of claim 7, further comprising:
a current collection plate including a current collection terminal electrically connected to the plurality of cells to transmit power of the plurality of cells to a contact target; and
a bus bar electrically connecting the terminal block and the current collection terminal to each other and disposed inside the enclosure.

9. The electrochemical stack assembly of claim 8, further comprising:
a pair of end plates connected to the current collection plate and the plurality of cells are arranged between the pair of end plates,
wherein the current collection terminal includes:
a positive terminal disposed in any one of the pair of end plates; and
a negative terminal disposed in a remaining one of the pair of end plates, and
wherein the bus bar includes:
a first bus bar connected to the positive terminal; and
a second bus bar connected to the negative terminal.

10. The electrochemical stack assembly of claim 9, wherein the terminal block includes:
a first terminal block connected to the first bus bar; and
a second terminal block connected to the second bus bar,
wherein the enclosure cover includes:
a first enclosure cover coupled to the first terminal block; and
a second enclosure cover coupled to the second terminal block, and
wherein the opening includes:
a first opening covered by the first enclosure cover; and
a second opening covered by the second enclosure cover.

11. The electrochemical stack assembly of claim 10, wherein the second opening is spaced apart from the first opening in the reference direction.

12. The electrochemical stack assembly of claim 11, wherein the fastening member includes a first fastening member that passes through a (1-1)^{th} hole of the enclosure and a (2-1)^{th} hole of the first enclosure cover to fasten the enclosure and the first enclosure cover to each other,
wherein the (2-1)^{th} hole includes a portion overlapping the (1-1)^{th} hole and is larger than the (1-1)^{th} hole, and
wherein the (1-1)^{th} hole overlaps an end of the (2-1)^{th} hole in a direction opposite to the reference direction when the first enclosure cover and the second enclosure cover are closest to each other in the reference direction.

13. The electrochemical stack assembly of claim 8, wherein the terminal block includes a terminal opening opens upward, and
wherein the bus bar has an exposure part exposed to an outside of the terminal block through the terminal opening.

14. The electrochemical stack assembly of claim 13, wherein the exposure part includes a region protruding outward from the terminal block.

15. The electrochemical stack assembly of claim 1, wherein:
the opening opens upward; and
wherein the enclosure cover is seated on an upper surface of the enclosure.

16. The electrochemical stack assembly of claim 1, wherein a size of the second hole is greater than a size of the first hole.
